(19) United States
(12) Patent Application Publication
(10) Pub. No.: US 2005/0210891 A1
(43) Pub. Date: Sep. 29, 2005

(54) Trans-critical refrigerating unit

(76) Inventors: Kenzo Matsumoto, Gunma (JP); Kazuaki Fujiwara, Gunma (JP); Yasuki Takahashi, Gunma (JP)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/079,922

(22) Filed: Mar. 14, 2005

(30) Foreign Application Priority Data
Mar. 15, 2004 (JP) 2004-073228

(51) Int. Cl. F25D 1/00; C09K 5/00; F25B 1/00; C10M 101/00; F25B 41/04; F25B 43/02; F25B 1/10

(52) U.S. Cl. 62/114; 252/68; 62/510; 62/468

(57) ABSTRACT

The present invention relates to a trans-critical refrigerating unit comprises a compressor 10, a gas cooler 154, a restriction means 156 and an evaporator 157 sequentially connected to each other, the trans-critical refrigerating unit using a refrigerant, which exhibits supercritical pressure on the high pressure side. In the unit, the compressor 10 includes compressing elements 32, 34 having a plurality of stages in a closed vessel 12, and after a discharge refrigerant in a lower-stage compressing element 32 in these compressing elements is discharged into the closed vessel 12 to dissipate heat, the refrigerant is further compressed by the subsequent-stage compressing element 34 to be discharged and a lubricating oil, which is compatible with said refrigerant and has a kinematic viscosity of 50 to 90 mm²/sec (@ 40° C.), is used. According to the trans-critical refrigerating unit of the present invention, the occurrence of sliding loss and leak loss is extremely suppressed and the maximum COP can be obtained.

### BACKGROUND OF THE INVENTION

1. Field of the Invention

The present invention relates to a trans-critical refrigerating unit comprised of a compressor, a gas cooler, a restriction means and an evaporator sequentially connected to each other, in which the high-pressure side is supercritical pressure.

2. Description of the Related Art

In a refrigerating cycle, as a refrigerant, Freon (R11, R12, R134a or the like) has been generally used. However, the emission of Freon to the atmosphere causes problems such as the significant earth's warning effect, the destruction of ozone layer and the like. Accordingly, in recent years a study using another natural refrigerant, which gives only a small influence to the environment, such as oxygen (O₂), carbon dioxide (CO₂), hydrocarbon (HC), ammonia (NH₃), water (H₂O) or the like has been made. Among these natural refrigerants, oxygen and water have low pressure and are impossible to use as a refrigerant in a refrigerating cycle. Since ammonia or hydrocarbon is flammable, there is a problem that it is difficult to handle. Thus a unit using a trans-critical refrigerant cycle, which uses carbon dioxide (CO₂) as a refrigerant and operates using the high-pressure side as supercritical pressure has been developed. This unit is disclosed in Japanese Laid-Open Patent Publication No. 10-19401 and Japanese Patent Publication No. 07-18602.

However, if carbon dioxide is used as a refrigerant, the refrigerant pressure reaches even 150 kg/cm² G on the high-pressure side. In a refrigerating cycle using carbon dioxide as a refrigerant so that the refrigerant pressure reaches about 30 to 40 kg/cm² G on the low pressure side, the refrigerant pressure of carbon dioxide is higher than that of Freon. Particularly, a one-stage compression type compressor is used, a portion where the high pressure side portion and the low pressure side portion are adjacent to the respective sliding members is caused. Since the differential pressure is large, the ensuring of an oil film becomes impossible due to high surface pressure and a slide loss or a leak loss is liable to occur, and further a lubricating oil reaches high temperature. Thus, as a lubricating oil, an existing oil such as PAG (polyalkylene glycol) and the like of a kinematic viscosity of 100 mm²/sec (@ 40° C.) class has been used. However, there is a problem of low COP.

### SUMMARY OF THE INVENTION

The object of the present invention is to solve the above-mentioned problems or to provide a trans-critical refrigerating unit, which extremely suppresses the occurrence of the slide loss and the leak loss so that maximum COP can be obtained.

To solve the above-mentioned object, a trans-critical refrigerating unit according to the first aspect of the present invention, comprising a compressor, a gas cooler, a restriction means and an evaporator sequentially connected to each other, said trans-critical refrigerating unit using a refrigerant, which exhibits supercritical pressure on the high pressure side, is characterized in that said compressor includes compressing elements having a plurality of stages in a closed vessel, and after a discharge refrigerant in a lower-stage compressing element of in these compression elements is discharged into said closed vessel to dissipate heat, the refrigerant is further compressed by the subsequent-stage compressing element of to be discharged and a lubricating oil, which is compatible with said refrigerant and has a kinematic viscosity of 50 to 90 mm²/sec (@ 40° C.), is used.

A trans-critical refrigerating unit according to the second aspect of the present invention, is characterized in that, in the trans-critical refrigerating unit according to the first aspect, carbon dioxide is used as a refrigerant and as said compressor a two-stage compression type rotary compressor is used.

A trans-critical refrigerating unit according to the third aspect of the present invention, is characterized in that, in the trans-critical refrigerating unit according to the first or second aspect, a lubricating oil is selected from among the members consisting of polyalkylene glycol, polyvinyl ether, polyol ester, mineral oil, and poly-alpha olefin.

A trans-critical refrigerating unit according to the fourth aspect of the present invention, is characterized in that in any one of the first to third aspects, a compressor provided with a closed vessel composed of an aluminum base material is used.

Thus, since the trans-critical refrigerating unit according to the first aspect of the present invention comprises a compressor, a gas cooler, a restriction means and an evaporator sequentially connected to each other, said trans-critical refrigerating unit using a refrigerant, which exhibits supercritical pressure on the high pressure side, and is characterized in that said compressor includes compressing elements having a plurality of stages in a closed vessel, and after a discharge refrigerant in a lower-stage compressing element in these compression elements is discharged into said closed vessel to dissipate heat, the refrigerant is further compressed by the subsequent-stage compressing element to be discharged and a lubricating oil, which is compatible with said refrigerant and has a kinematic viscosity of 50 to 90 mm²/sec (@ 40° C.) is used, the pressure of the refrigerant discharged into the closed vessel exhibits an intermediate pressure between the high pressure side and the low pressure side, the respective sliding members have no position where the high pressure side portion and the low pressure side are adjoined to each other, and instead a position where the high pressure side portion and the intermediate pressure side portion are adjoined or a position where the intermediate pressure side portion and the low pressure side portion are adjoined are formed. Thus since the differential pressure becomes small and the surface pressure is lowered so that an oil film is ensured, the occurrence of the slide loss and the leak loss can be suppressed. Since the lubricating oil does not reach high temperature, the maximum COP can be obtained. These are remarkable effects in the present invention.

Since the trans-critical refrigerating unit according to the second aspect of the present invention, is characterized in that, in the trans-critical refrigerating unit according to the first aspect, carbon dioxide is used as a refrigerant and as said compressor a two-stage compression type rotary compressor is used, in the case where carbon dioxide is used as a refrigerant, the refrigerant pressure reaches even about 150 kg/cm² G on the high pressure side and it reaches about 30 to 40 kg/cm² G on the low pressure side. However, the differential pressure in the respective sliding members becomes about ½, which is small, and the surface pressure is decreased so that an oil film is ensured. Accordingly, the occurrence of the slide loss and the leak loss can be extremely suppressed, and the maximum COP can be reliably obtained. These are remarkable effects in the present invention.

Further, the trans-critical refrigerating unit according to the third aspect of the invention, is characterized in that, in the trans-critical refrigerating unit according to the first or second aspect, a lubricating oil is selected from among the members consisting of polyalkylene glycol, polyvinyl ether, polyol ester, mineral oil, and poly-alpha olefin. Thus, the lubricating oil has high compatibility, lubricity, and stability and is easily available and inexpensive. Thus, the unit can improve the reliability. These are also remarkable effects in the present invention.

Further, the trans-critical refrigerating unit according to the fourth aspect of the present invention, is characterized in that in any one of the first to third aspect, a compressor provided with a closed vessel composed of an aluminum base material is used. Thus, since the aluminum base material has excellent thermal conductivity, the heat dissipation of the refrigerant discharged into said closed vessel can be easily made. Additionally, the weight saving of the compressor can be effected. These are remarkable effects in the present invention.

### BRIEF DESCRIPTION OF THE DRAWINGS

FIG. 1 is an explanatory view showing one embodiment of a compressor used in a trans-critical refrigerating unit according to the present invention,

FIG. 2 is a refrigerant circuit diagram of the trans-critical refrigerating unit of the present invention including the compressor shown in FIG. 1,

FIG. 3 is p-h diagram of the refrigerant circuit in FIGS. 2 and 4,

FIG. 4 is a refrigerant circuit diagram of another trans-critical refrigerating unit of the present invention, and

FIG. 5 is a graph showing a relationship between COP and a lubricating oil kinematic viscosity (mm²/sec) (40° C.).

### DETAILED DESCRIPTION OF THE PREFERRED EMBODIMENT

Preferred embodiments of the present invention will be described below in detail with reference to drawings.

(First Embodiment)

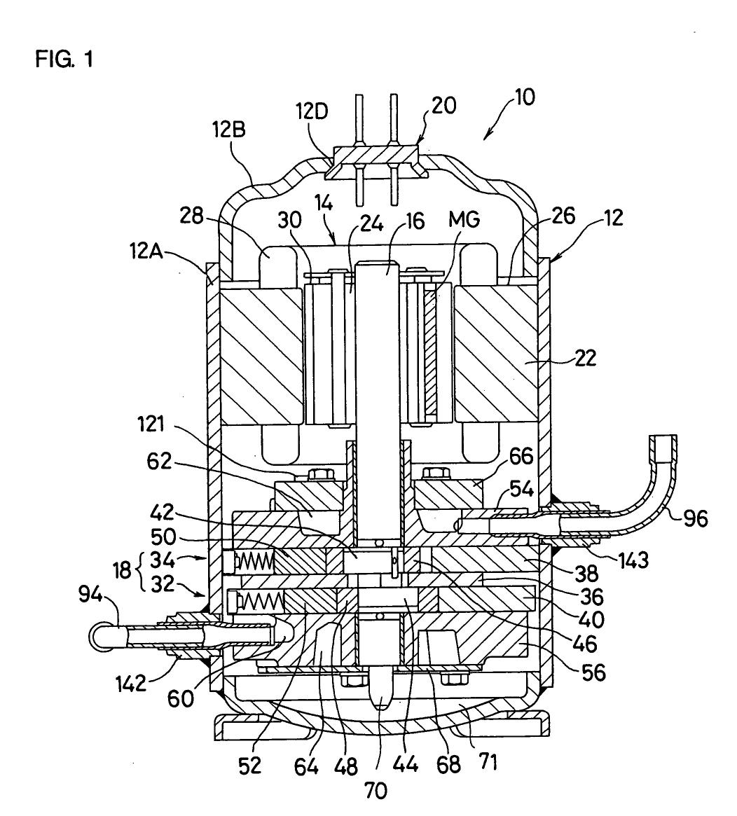

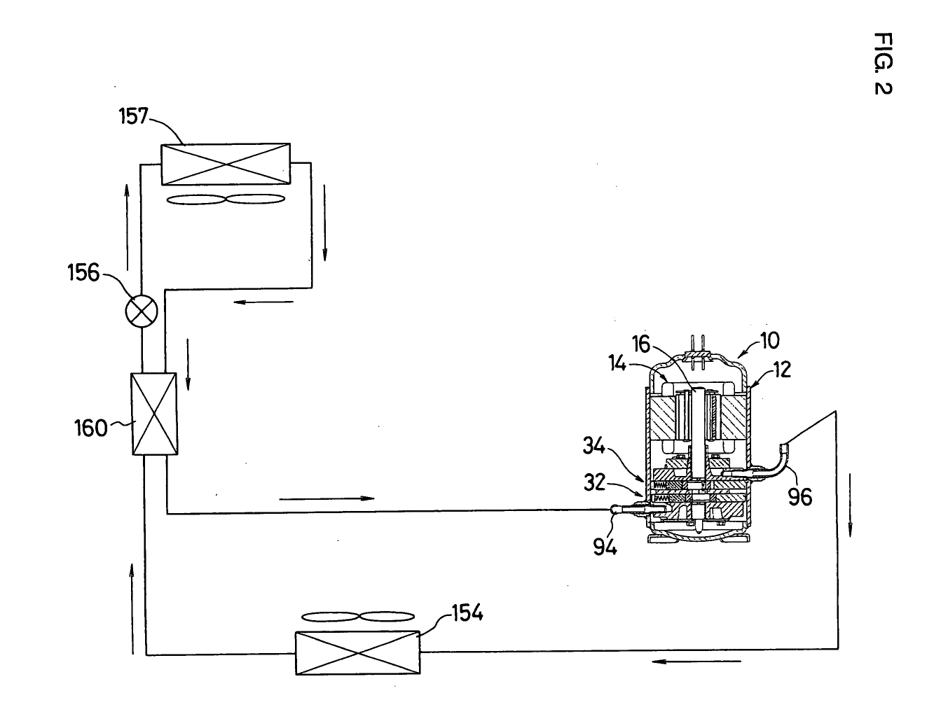

FIG. 1 is a vertical cross-sectional side view of an inside intermediate pressure type multi-stage (two-stage) compressing rotary compressor 10 including lower stage and upper stage rotary compressing elements 32 and 34 as an example of a compressor used in a trans-critical refrigerating unit according to the present invention, and FIG. 2 is a refrigerant circuit diagram of the trans-critical refrigerating unit according to the present invention. It is noted that the trans-critical refrigerating unit of the present invention has been used in a vending machine, an air conditioner, a refrigerator, a showcase, a car or the like.

In the respective drawings, the reference numeral 10 denotes an inside intermediate pressure type multi-stage compressing rotary compressor, which uses carbon dioxide (CO₂) as a refrigerant. This compressor 10 is comprised of a cylindrical closed vessel 12 made of an aluminum base metal, a motor-operating element 14 disposed and accommodated on the an upper side of the internal space of this closed vessel 12, and a rotary compressing mechanism 18 consisting of a lower stage rotary compressing element 32 (first stage) disposed on the lower side of this motor-operating element 14 and driven by a rotating shaft 16 of the motor-operating element 14, and an upper stage rotary compressing element 34 (second stage).

The closed vessel 12 functions as a lubricating oil reservoir for supplying the respective slide portions with a lubricating oil to lubricate, in the bottom portion, and is comprised of a vessel body 12A accommodating the motor-operating element 14 and the rotary compressing mechanism portion 18, and a substantially bowl-shaped end cap (lid body) 12B, which closes an upper opening of this vessel body 12A. Further, at the center of the top surface of this end cap is formed a circular mounting hole 12D to which a terminal (wiring omitted) 20 for supplying the motor-operating element 14 with electric power is attached.

The motor-operating element 14 is so-called a magnetic pole concentrated-winding type DC motor and is comprised of a stator 22 mounted annularly along an inner circumferential surface of the closed vessel in the upper space thereof, and a rotor 24 inserted inside this stator 22 with a small space. This rotor 24 is fixed to a rotating shaft 16 passing through the center and extending in the vertical direction.

The stator 22 has a laminated body 26 laminated with donut-shaped electromagnetic steel sheets and a stator coil 28 wound by a series winding (concentrated winding) mode on teeth portions of the laminated body. Further, the rotor 24 is formed of an electromagnetic steel sheet laminated body 30 as well as the stator 22 and formed by inserting a permanent magnet (MG) in this laminated body 30.

Between the lower stage rotary compressing element 32 and the upper stage rotary compressing element 34 is sandwiched an intermediate partition plate 36. That is the lower stage rotary compressing element 32 and the upper stage rotary compressing element 34 are comprised of the intermediate partition plate 36, an upper cylinder 38 and a lower cylinder 40 respectively disposed over and under the intermediate partition plate 36, upper and lower rollers 46 and 48 eccentrically rotated by upper and lower eccentric portions 42 and 44 provided on the rotating shaft 16 in the upper and lower cylinders 38 and 40 with a phase difference of 180 degrees therebetween, vanes 50 and 52, which abut on the upper and lower rollers 46 and 48 respectively and defines the upper and lower cylinders 38 and 40 into the low pressure chamber side and the high pressure chamber side respectively, and an upper portion supporting member 54 and a lower portion supporting member 56, which close an upper side opening surface of the upper cylinder 38 and a lower side opening surface of the lower cylinder 40 respectively and function as a supporting member, which also act bearings for the rotating shaft 16.

On the other hand, in the upper portion supporting member 54 and the lower portion supporting member 56 are provided recessed suction passages 60 (upper suction passage not shown) respectively communicating with the inside of the upper and lower cylinders 38 and 40 by suction ports not shown and discharge muffling chambers 62 and 64 formed by closing the recessed portions, which are formed by caving a portion of the upper and lower portion support members 54, 56, with a upper cover 66 and a lower cover 68.

It is noted that the discharge muffling chamber 64 communicates with the inside of the closed vessel 12 with a connecting passage penetrating through the upper and lower cylinders 38, 40 and the intermediate partition plate 36. An intermediate discharge pipe 121 is vertically provided on the upper end of the connecting passage, and a refrigerant gas compressed with the lower stage rotary compressing element 32 into intermediate pressure is discharged into the closed vessel 12 from the intermediate discharge pipe 121.

On a side surface of the vessel body 12A of the closed vessel 12 are welding-fixed sleeves 142 and 143 at positions corresponding to the suction passages 60 (upper side not shown) of the upper portion supporting member 54 and the lower portion supporting member 56, the discharge muffling chamber 62 and the upper side of the upper cover 66 (position substantially corresponding to the lower end of the motor-operating element 14) respectively.

Further, one end of the refrigerant introduction pipe 94 for introducing a refrigerant gas into the lower cylinder 40 is inserted into the sleeve 142 and connected thereto, and the end of this refrigerant introduction pipe 94 is communicated with the suction passage 60 of the lower cylinder 40. The other end of this refrigerant introduction pipe 94 is connected to a first heat exchanger 160. Further, a refrigerant discharge pipe 96 is insertion-connected into the sleeve 143 and the other end of the refrigerant discharge pipe 96 communicates with the discharge muffling chamber 62.

Next, in FIG. 2, the above-mentioned compressor 10 forms a part of the refrigerant circuit shown in FIG. 2. That is the refrigerant discharge pipe 96 in the compressor 10 is connected to an inlet of a gas cooler 154. Then the pipe line extending from this gas cooler 154 passes through a first heat exchanger 160. The first heat exchanger 160 heat-exchanges between a high pressure side refrigerant emitted from the gas cooler 154 and a low pressure side refrigerant emitted from an evaporator 157.

The refrigerant, which has passed through the first heat exchanger 160 reaches an expansion valve 156 as a restriction means. Then the outlet of the expansion valve 156 is connected to the inlet of an evaporator 157, and the pipe line extending from the evaporator 157 is connected to the refrigerant introduction pipe 94 through the first heat exchanger 160.

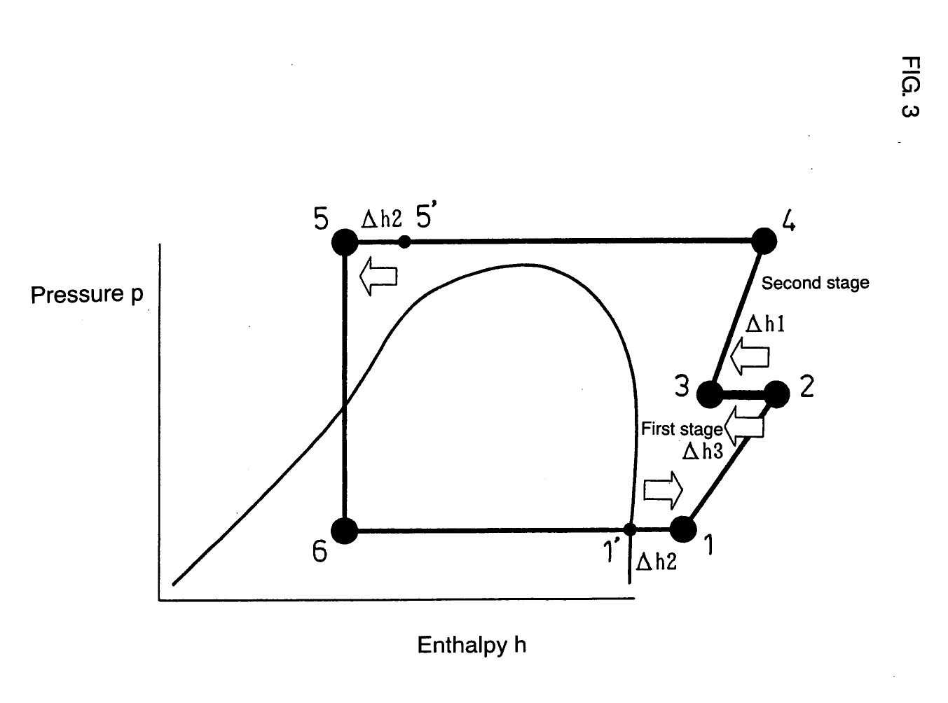

Next, the operation of the trans-critical refrigerating unit of the present invention having the above-mentioned configuration will be described while referring to a p-h diagram (Mollier chart) in FIG. 3. When the stator coil 28 of the motor-operating element 14 in the compressor 10 is energized through the terminal 20 and wiring not shown, the motor-operating element 14 is started to rotate the rotor 24. This rotation eccentrically rotates the upper and lower rollers 46 and 48 respectively fitted to the upper and lower eccentric portions 42 and 44 integrally provided with the rotating shaft 16 in the upper and lower cylinders 38 and 40.

Thus, a low pressure (a state of 1 in FIG. 1) refrigerant gas sucked from a suction port not shown to the low pressure chamber side of the cylinder 40 through a refrigerant introduction pipe 94 and the suction passage 60 formed in the lower portion supporting member 56, is compressed by operations of the roller 48 and the vane 52 to reach intermediate pressure and passes through the connecting passage not shown through the high pressure chamber side of the lower cylinder 40 and then discharged from the intermediate discharge pipe 121 to the inside of the closed vessel 12. Accordingly, the inside of the closed vessel 12 reaches intermediate pressure (a state of 2 in FIG. 3).

The refrigerant discharged into the closed vessel 12 is heat-lost from the outside in the closed vessel 12 of an aluminum base metal and cooled. At this time the refrigerant loses enthalpy by Δh1 (a state of 3 in FIG. 3).

Then the intermediate pressure refrigerant gas is sucked from a suction port not shown to the low pressure chamber side of the upper cylinder 38 of the upper stage rotary compressing element 34 through a not-shown suction passage, formed on the upper portion supporting member 54 and the second stage compression of the refrigerant gas is made by operations of the roller 46 and vane 50 so that the refrigerant gas becomes a high pressure, high temperature refrigerant gas. Then the refrigerant gas passes through the discharge port (not shown) from the high pressure chamber side and is discharged from the refrigerant discharge pipe 96 to the outside through the discharge muffling chamber 62 formed in the upper portion supporting member 54. Then the refrigerant gas has been compressed to an appropriate supercritical pressure (a state of 4 in FIG. 3).

The refrigerant gas discharged from the refrigerant discharge pipe 96 flows into the gas cooler 154 and after it is heat-dissipated by an air-cooling mode (a state of 5′ in FIG. 3), it passes through the first heat exchanger 160. The refrigerant gas is heat-lost by a low pressure side refrigerant thereby to be further cooled. Thus, for example a medium and high temperature region of +12° C. to −10° C. for an evaporation temperature of the refrigerant gas in the evaporator 157 can be easily attained (a state of 5 in FIG. 3).

The high-pressure side refrigerant gas cooled by the first heat exchanger 160 reaches the expansion valve 156. The refrigerant gas is still under a condition of gas at the inlet of the expansion valve 156. The refrigerant is made to be a two-phase mixture of gas/liquid by pressure reduction in the expansion valve 156 (a state of 6 in FIG. 3), and flows into the evaporator 157 in its condition. The refrigerant is evaporated there and exhibits a cooling action by heat absorption from the air.

After that the refrigerant flows out of the evaporator 157 (a state of 1′ in FIG. 3) and passes through the first heat exchanger 160. It takes heat from said high pressure side refrigerant there and is subjected to a heating action so that the enthalpy of the refrigerant is increased by Δh2. As a result the refrigerant perfectly becomes in a gas state (a state of 1 in FIG. 3).

The gas state refrigerant repeats a cycle of being sucked from the refrigerant introduction pipe 94 to the inside of the lower stage rotary compressing element 32.

The rotating shaft 16 is provided with an oil supply hole (not shown), which supplies the respective sliding portions such as compressing elements 32, 34 and bearings, at the center thereof, and an oil pickup 70 communicating with the oil supply hole is attached to a lower end of the rotating shaft 16. The lower end of the oil pickup 70 is immersed into a lubricating oil 71 in the lubricating oil reservoir. The oil pickup 70 is integrally formed with a paddle not shown, which enhances the oil supply performance.

When the rotating shaft 16 is rotated, the lubricating oil 71 in the lubricating oil reservoir is supplied by centrifugal force from the oil pickup 70 attached to the lower end of the rotating shaft 16 to the respective sliding portions of the bearings and compressing elements 32 and 34. Then after the lubricating oil 71 has lubricated the respective sliding portions, it is returned into the lubricating oil reservoir so that it is used in a circulative manner.

On the other hand, lubricating oil entrained in refrigerant gas discharged from the refrigerant discharge pipe 96 is sucked together with refrigerant from the refrigerant introduction pipe 94 into the lower stage rotary compressing element 32 in the compressor 10 through the refrigerant circuit to lubricate the respective sliding portions.

As the lubricating oil used in the present invention, lubricating oil of a kinematic viscosity of 50 to 90 mm²/sec (@ 40° C.) having compatibility with a refrigerant is used.

In case where carbon dioxide is used as a refrigerant, the refrigerant pressure reaches even about 150 kg/cm² G on the high pressure side and about 30 to 40 kg/cm² G on the low pressure side. However, since an inside intermediate pressure type multi-stage (two stage) compressing rotary compressor 10 is used, the differential pressure in the respective sliding members becomes about ½, which is small, and the surface pressure is decreased and a lubricating oil film is sufficiently ensured. Thus the occurrence of the slide loss and leak loss can be extremely suppressed. Further, since the lubricating oil does not reach high temperature of 100° C. or higher, the maximum COP can be obtained by use of lubricating oil having the kinematic viscosity in said region lower than that of a lubricating oil.

In case where the kinematic viscosity is less than 50 mm²/sec (@ 40° C.), the sealing properties is inferior and the leak loss is liable to be increased. When the kinematic viscosity exceeds 90 mm²/sec (@ 40° C.), shear friction is increased and the electric power consumption is liable to be increased. By using the lubricating oil in a range of said kinetic viscosity the occurrence of the sliding loss and leak loss is extremely suppressed and the maximum COP can be obtained.

The lubricating oil used in the present invention is not limited particularly, and lubricating oil such as natural oil or oil of natural origin or synthetic products or their mixture may be used.

As mineral oil, oil such as a paraffin base oil or a naphthene base oil, or a normal paraffin oil, obtained by refining a lubricating oil fraction obtained by atmospheric distillation and vacuum distillation of crude oil by appropriately combining refining processes such as solvent deasphalting, solvent extraction, hydrocracking, solvent dewaxing, contact dewaxing, hydrorefining, sulfuric acid cleaning, clay processing and the like, can be used specifically.

As the synthetic products, specifically for example, poly-a-olefin (polybutene, 1-octene oligomer, 1-decenoligomer, or the like), isoparaffin, alkylbenzene, alkylnaphthalene, dibasic acid ester (ditridecyl glutalete, di-2-ethylhexyl adipate, di-isodecyl adipate, di-tridecyl adipate, di-2-ethylhexyl sebacate or the like), tribasic acid ester (trimellitic acid ester or the like), polyol easter (trimethylolpropane caprylate, trimethylolpropane pelargonate, pentaerythritol, 2-ethylhexanoate, pentaerythritol pelargonate, or the like) polyoxyalkylene glycol, polyalkylene glycol, dialkyldiphenyl ether, polyphenyl ether, polyvinyl ether, or the like can be used.

It is noted that these mineral oil and synthetic products may be singly used, or two types or more of oils selected from the group may be used by combining them at an arbitrary mixing rate.

A lubricating oil selected from the group of polyalkylene glycol (PAG), polyvinyl ether (PVE), polyol ester (POE), mineral oil, and poly-alpha olefin (PAO) is excellent in compatibility, lubricity, and cooling power (heat-removal power), and has small friction loss due to stirring resistance. Further, the lubricating oil has high stability and is easily available, and it is inexpensive and the reliability can be improved. Thus these oils can be preferably used in the present invention.

To the lubricating oil used in the present invention may be further added known additives such as tricresyl phosphate (TCP), epoxy consisting of glycidyl ether, carbodiimido, oxidation inhibitor, rust inhibitor, corrosion inhibitor, pour point depressant, antifoaming agent, and extreme-pressure agent singly or in combination of several types of the additives for the purpose of enhancing various performance.

As an oxidation inhibitor, a phenol base compound or an amine base compound or the like, which is generally used in lubricating oil may be used. Specifically, the oxidation inhibitors include alkyl phenols such as 2,6-di-tert-butyl-4-methylphenol, bisphenols such as methylene-4,4-bis (2,6-di-tert-butyl-4-methylphenol), naphthylamines such as phenyl-α-naphtylamine, dialkyl dithiozincphosphates such as di-2-ethylhexyl dithiozincphosphate.

The rust inhibitors specifically include aliphatic amines, organic phosphite, organic phosphate, organic metal sulfonate, organic metal phosphate, alkenyl succinate ester, polyhydric alcohol ester and the like.

The corrosion inhibitors specifically include benzotriazole base compounds, thiadiazole base compounds, imidazole base compounds and the like.

The pour point depressants specifically include polymethacrylate base polymer and the like applicable to lubricating oil used.

Further, the antifoaming agents specifically include silicones such as dimethyl silicone.

The addition amount of these known additives are arbitrary. However, if they are used, the content of oxidation inhibitor of 0.01 to 5.0 mass %, the contents of rust inhibitor and corrosion inhibitor of 0.01 to 3.0 mass % respectively, the content of pour point depressant of 0.05 to 5.0 mass %, and the content of antifoaming agent of 0.01 to 0.05 mass % are preferably usually added to the lubricating oil with respect to the all amounts of the lubricating oil.

(Second Embodiment)

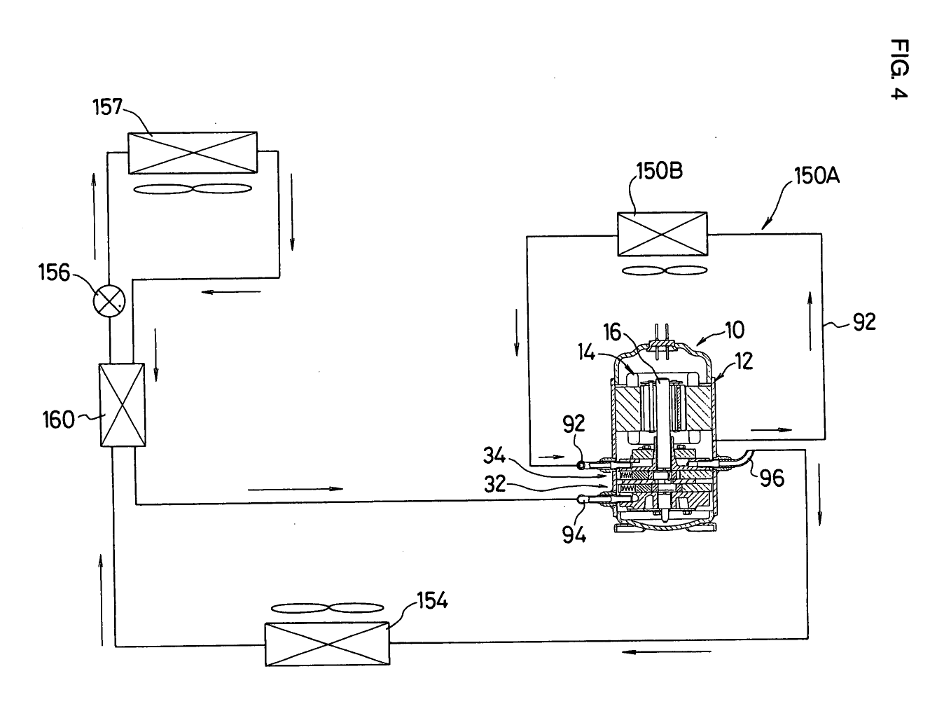

FIG. 4 is a refrigerant circuit diagram of another trans-critical refrigerating unit according to the present invention.

In FIG. 4, the reference numeral 10 denotes an inside intermediate pressure type multi-stage (two-stage) compressing rotary compressor, which uses carbon dioxide (CO₂) as a refrigerant, and is comprised of a motor-operating element 14 in a cylindrical closed vessel 12, a lower stage rotary compressing element 32, which is driven with a rotating shaft 16 of the motor-operating element 14 and an upper stage rotary compressing element 34. In the closed vessel 12, a bottom portion functions as a lubricating oil reservoir, which send lubricating oil used in the present invention to the respective sliding portions to lubricate them.

The compressor 10 compresses a refrigerant gas sucked from a refrigerant introduction pipe 94 with the lower rotary compressing element 32 and discharges it into the closed vessel 12. Then the compressor 10 once discharges an intermediate pressure refrigerant gas in the closed vessel 12 from a refrigerant introduction pipe 92 to an intermediate cooling circuit 150A. The refrigerant gas is air-cooled by passing through an intermediate cooling heat exchanger (intercooler) 150B and is sucked into the upper stage rotary compressing element 34 to be compressed. The trans-critical refrigerating unit of the second embodiment is substantially the same as the trans-critical refrigerating unit of the first embodiment in the present invention shown in FIGS. 1 and 2 except for the above description.

That is the refrigerant gas, which has become high pressure refrigerant gas by the second stage compression, is discharged from a refrigerant discharge pipe 96, and is air-cooled by a gas cooler 154. After the refrigerant emitted from this gas cooler 154 is heat-exchanged with a refrigerant emitted from an evaporator 157 by a first heat exchanger 160, it enters the evaporator 157 through an expansion valve 156, and is evaporated. The refrigerant is sucked from the refrigerant introduction pipe 94 into the lower stage rotary compressing element 32 through the internal heat exchanger 160 again.

The operation in this case will be described with reference to the p-h diagram of FIG. 3. A refrigerant is compressed by the lower rotary compressing element 32 (enthalpy of Δh3 is obtained) to have intermediate pressure, and the refrigerant (a state of 2 in FIG. 3) discharged into the closed vessel 12 flows into the intermediate cooling circuit 150A through the refrigerant introduction pipe 92. Then the refrigerant flows into an intermediate cooling heat exchanger 150B through which the intermediate cooling circuit 150A passes, and is heat dissipated by an air-cooling method (a state of 3 in FIG. 3) there. The intermediate pressure refrigerant loses enthalpy by Δh1 in the intermediate cooling heat exchanger 150B as shown in FIG. 3.

After that the refrigerant is sucked into the upper stage rotary compressing element 34 and is subjected to the second stage compression to be high pressure, high temperature refrigerant gas. Then the refrigerant gas is discharged to the outside through the refrigerant discharge pipe 96. Then the refrigerant has been compressed to an appropriate supercritical pressure (a state of 4 in FIG. 3).

The refrigerant gas discharged through the refrigerant discharge pipe 96 flows into the gas cooler 154 and is heat-dissipated by an air-cooling method there (a state of 5′ in FIG. 3). After that the refrigerant gas passes through the first heat exchanger 160. Then the refrigerant is heat-taken by a low-pressure side refrigerant there so that it is further cooled (a state of 5 in FIG. 3) (enthalpy is lost by Δh2). After that the refrigerant is pressure-reduced by the expansion valve 156 so that it becomes in a gas/liquid mixing state (a state of 6 in FIG. 3). Then the refrigerant flows into the evaporator 157 to be evaporated (a state of 1′ in FIG. 3). The refrigerant emitted from the evaporator 157 passes through the first heat exchanger 160 and is heated there by taking heat from the high pressure side refrigerant (a state of 1 in FIG. 3) (enthalpy of Δh2 is obtained).

And the refrigerant heated by the first heat exchanger 160 repeats a cycle in which the refrigerant is sucked from the refrigerant introduction pipe 94 into the lower stage rotary compressing element 32.

In this case, carbon dioxide is used as a refrigerant. However, as mentioned above, since the inside intermediate pressure type multi-stage (two-stage) compressing rotary compressor 10 has been used, the differential pressure in the respective sliding members becomes about ½, which is small, and the surface pressure is lowered so that a lubricating oil film is sufficiently ensured. Thus the occurrence of the sliding loss and leak loss can be extremely suppressed. Since the lubricating oil does not reach high temperature of 100° C. or more so that the maximum COP can be obtained by use of a lubricating oil having a kinematic viscosity in the range lower than a conventional kinematic viscosity.

The description of the above-mentioned embodiment is made for explaining the present invention, and does not limit the inventions according to claims or does not restrict the claims. Further, the respective configurations of the present invention are not limited to the above-mentioned embodiments and for example the following various modifications are possible in technical scopes described in claims.

Although in the above description, the two-stage compressing type rotary compressor has been described, the type of the compressor in the present invention is not limited particularly. Specifically, a reciprocating compressor, a vibration type compressor, a multi-vane type rotary compressor, a scroll type compressor and the like may be used, and the number of compressing stages may be at least two stages or more, that is a multi-stage compression may be used.

Further, in the above description an example in which a refrigerant emitted from the evaporator is passed through the first heat exchanger and is heat-exchanged with a high pressure side refrigerant so that it becomes in a perfectly gas state, has been made. However, a receiver tank may be provided on the low pressure side between the outlet side of the evaporator and the suction side of the compressor in place of the use of the first heat exchanger.

Next, the present invention will be described in detail by examples and a comparative example. However, the present invention is not limited to these examples.

### EXAMPLE 1

Using the trans-critical refrigerating unit of the present invention including the refrigerant circuit shown in FIG. 4 and carbon dioxide (CO₂) as a refrigerant, and using the lubricating oil described in Table 1, test running was carried out under two stage compressing conditions of high pressure side pressure of 9 MPa and low pressure side pressure of 3 Mpa. The obtained results of refrigerating capacity, input, COP and number of revolutions are shown in Table 2.

TABLE 1

Kinematic viscosity (mm²/sec)

| Lubricating oil | 40° C. | 100° C. |
|---|---|---|
| PAG 46 | 46 | 10 |
| PAG 68 | 68 | 14 |
| PAG 100 | 100 | 20 |

TABLE 2

| | PAG 46 | PAG 68 | PAG 100 |
|---|---|---|---|
| Refrigeration capacity | 95 | 100 | 100 |
| Input | 95 | 96 | 100 |
| COP | 100 | 104 | 100 |
| Number of revolutions (rpm) | 3485 | 3482 | 3477 |

### EXAMPLE 2

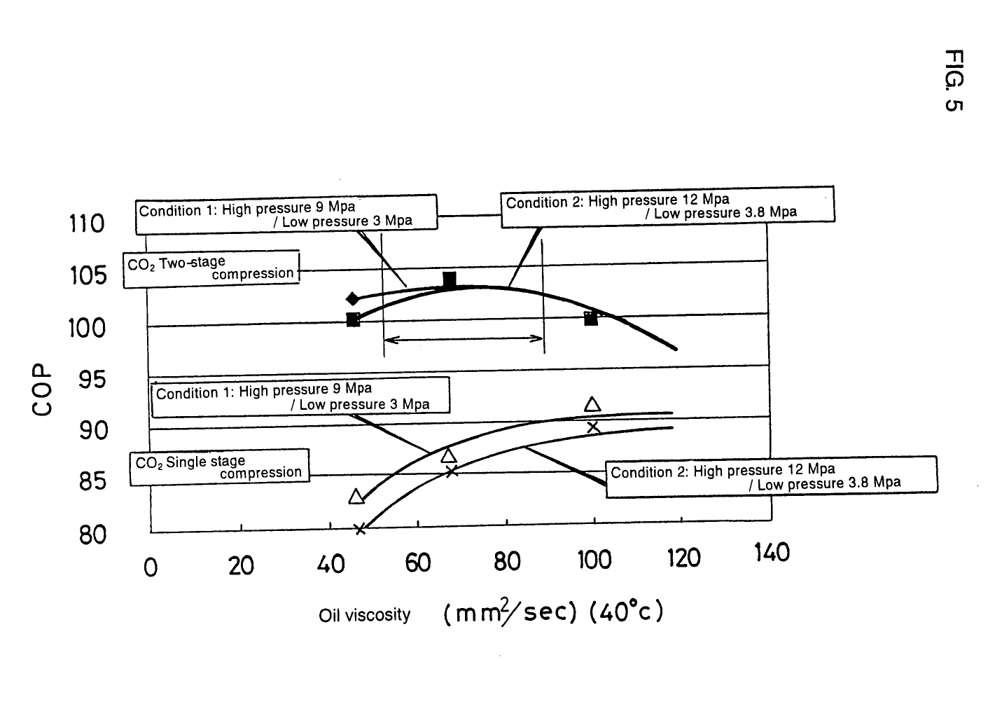

Using the lubricating oils described in Table 1 under the following two stage compressing conditions 1 and 2, test running was carried out in the same manner as in Example 1 except that two-stage compression was performed. The obtained results of COP are shown in Table 3 and FIG. 5.
(two-stage compression condition 1) high pressure side pressure 9 Mpa
   low pressure side pressure 3 Mpa
(two-stage compression condition 2) high pressure side pressure 12 Mpa
   low pressure side pressure 3.8 Mpa

### COMPARATIVE EXAMPLE 1

Using the lubricating oils described in Table 1 under the following single stage compressing conditions 1 and 2, test running was carried out in the same manner as in Example 1 except that a single stage compression was performed. The obtained results of COP are shown in Table 3 and FIG. 5.
(single-stage compression condition 1) high pressure side pressure 9 Mpa
   low pressure side pressure 3 Mpa
(single-stage compression condition 2) high pressure side pressure 12 Mpa

low pressure side pressure 3.8 Mpa

TABLE 3

| | PGA 46 | PGA 68 | PGA 100 |
|---|---|---|---|
| Two-stage compression condition 1 | 102 | 104 | 100 |
| Two-stage compression condition 2 | 100 | 104 | 100 |
| Single-stage compression condition 1 | 83 | 87 | 92 |
| Single-stage compression condition 2 | 80 | 85 | 90_{—} |

It can be seen from Table 3 and FIG. 5 that when lubricating oils in the range (within a range shown by an arrow) of kinematic viscosity of 50 to 90 mm²/sec (@ 40° C.), the maximum COP can be obtained. On the other hand, it is found that in the case of the single-stage compression in Comparative Example 1 high COP cannot be obtained.

The trans-critical refrigerating unit according to the present invention comprises a compressor, a gas cooler, a restriction means and an evaporator sequentially connected to each other, said trans-critical refrigerating unit using a refrigerant, which exhibits supercritical pressure on the high pressure side, and is characterized that said compressor includes a compressing element having a plurality of stages in a closed vessel, and after a discharge refrigerant in a compressing element of a lower stage in these compression element is discharged into said closed vessel to dissipate heat, the refrigerant is further compressed by a compressing element of a rear stage to be discharged and a lubricating oil, which is compatible with said refrigerant and has a kinematic viscosity of 50 to 90 mm²/sec (@ 40° C.) is used.

The refrigerant pressure discharged into said closed vessel becomes an intermediate pressure between the high pressure side and the low pressure side, the differential pressure in the respective sliding portions is decreased and the surface pressure is lowered so that an oil film is ensured. Thus, the generation of the sliding loss and leak loss can be extremely suppressed. Further, since the lubricating oil does not reach high temperature, the maximum COP can be obtained. These effects are remarkable effects and the present invention has high industrial availability.

1. A trans-critical refrigerating unit comprising a compressor, a gas cooler, a restriction means and an evaporator sequentially connected to each other, said trans-critical refrigerating unit using a refrigerant, which exhibits supercritical pressure on the high pressure side,
wherein said compressor includes compressing elements having a plurality of stages in a closed vessel, and after a discharge refrigerant in a lower-stage compressing element in these compressing elements is discharged into said closed vessel to dissipate heat, the refrigerant is further compressed by the subsequent-stage compressing element to be discharged and a lubricating oil, which is compatible with said refrigerant and has a kinematic viscosity of 50 to 90 mm²/sec (@ 40° C.), is used.

2. The trans-critical refrigerating unit according to claim 1, wherein carbon dioxide is used as a refrigerant and as said compressor a two-stage compression type rotary compressor is used.

3. The trans-critical refrigerating unit according to claim 1, wherein a lubricating oil is selected from the members consisting of polyalkylene glycol, polyvinyl ether, polyol ester, mineral oil, and poly-alpha olefin.

4. The trans-critical refrigerating unit according to claim 1, wherein a compressor provided with a closed vessel composed of an aluminum base material is used.

5. The trans-critical refrigerating unit according to claim 2, wherein a lubricating oil is selected from the members consisting of polyalkylene glycol, polyvinyl ether, polyol ester, mineral oil, and poly-alpha olefin.

6. The trans-critical refrigerating unit according to claim 2, wherein a compressor provided with a closed vessel composed of an aluminum base material is used.

7. The trans-critical refrigerating unit according to claim 3, wherein a compressor provided with a closed vessel composed of an aluminum base material is used.

8. The trans-critical refrigerating unit according to claim 5, wherein a compressor provided with a closed vessel composed of an aluminum base material is used.
